(19) United States
(12) Patent Application Publication
(10) Pub. No.: US 2026/0108835 A1
(43) Pub. Date: Apr. 23, 2026

(54) ASSEMBLED-TYPE FILTER STRUCTURE

(71) Applicant: Zhongshan Lvyuan Environmental Purification Technology Co., Ltd., Zhongshan (CN)

(72) Inventor: Min ZHONG, Zhongshan (CN)

(73) Assignee: Zhongshan Lvyuan Environmental Purification Technology Co., Ltd., Zhongshan (CN)

(21) Appl. No.: 19/426,133

(22) Filed: Dec. 19, 2025

(30) Foreign Application Priority Data
Oct. 31, 2025 (CN) 202522317716.0

(51) Int. Cl. B01D 46/00; B01D 46/52

(52) U.S. Cl. CPC B01D 46/0005; B01D 46/521; B01D 2265/06; B01D 2279/50

(57) ABSTRACT

An assembled-type filter structure, comprising a filter body, a first frame assembly, and a second frame assembly detachably connected to the first frame assembly, the first frame assembly and the second frame assembly are connected and matched for the filter body to be expanded and joined with the first and the second frame assemblies, and to fill a mounting opening formed by connecting the first frame assembly with the second frame assembly. The assembled-type filter structure of the present invention, enables the filter to be disassembled and folded during transportation and storage, significantly reducing packaging volume of finished product and lowering logistics costs and warehousing pressure. Meanwhile, during installation, a connecting and matching process of the first frame assembly and the second frame assembly provides structural support and positioning for the expansion of the filter body, enabling it to be easily expanded and to fill the formed mounting opening.

### RELATED APPLICATIONS

The present patent document claims the benefit of priority to Patent Application No. 202522317716.0, filed October 31, 2025, and entitled “ASSEMBLED-TYPE FILTER STRUCTURE,” the entire contents of each of which are incorporated herein by reference.

### BACKGROUND

### 1. Technical Field

The present invention relates to the technical field of air purification, and in particular to an assembled- type filter structure.

### 2. Background Information

Filter is a key component to ensure the air quality. Existing filter products, such as those used in HVAC (Heating, Ventilation, and Air Conditioning) systems or fresh air systems, adopt an integrally fixed structure between the frame and the filter body. Although structurally stable in the finished product state, the non-detachable frame in practical applications results in excessively large finished product and packaging volume of the filter. This occupies a large amount of space during transportation and storage, leading to high logistics costs and warehousing pressure. Second, for a foldable filter, during installation, hanging pieces need to be provided at upper and lower ends of the filter, and manual alignment with installation rails on upper and lower sides of an air duct is required for stretching the filter open. This makes the installation process cumbersome and time-consuming, reducing operational efficiency.

### BRIEF SUMMARY

In order to solve the problem in the prior art that the frame and the body of the filter adopt an integrally fixed structure, resulting in an excessively large finished product volume of the filter, the present invention provides an assembled-type filter structure.

The present invention is achieved by the following technical solutions.

An assembled-type filter structure, comprising a filter body, a first frame assembly, and a second frame assembly detachably connected to the first frame assembly, wherein the first frame assembly and the second frame assembly are connected and matched for the filter body to be expanded and joined with the first frame assembly and the second frame assembly, and to fill a mounting opening formed by connecting the first frame assembly with the second frame assembly.

The assembled-type filter structure as described above, the first frame assembly comprises a first frame member and a second frame member that are connected to two ends of the filter body along a stretching direction, the second frame assembly comprises a third frame member and a fourth frame member that are detachably connected to the first frame member and the second frame member, and are configured for supporting and expanding the filter body.

The assembled-type filter structure as described above, the filter body is detachably connected to the first frame member and the second frame member.

The assembled-type filter structure as described above, two ends of the first frame member are provided with a first connecting hole and a second connecting hole respectively, two ends of the second frame member are provided with a third connecting hole and a fourth connecting hole respectively, two ends of the third frame member are provided with a fifth connecting hole and a sixth connecting hole respectively, two ends of the fourth frame member are provided with a seventh connecting hole and an eighth connecting hole respectively; a first fastener passes through the first connecting hole and the fifth connecting hole for connecting the first frame member and the third frame member; a second fastener passes through the second connecting hole and the seventh connecting hole for connecting the first frame member and the fourth frame member; a third fastener passes through the third connecting hole and the sixth connecting hole for connecting the second frame member and the third frame member; a fourth fastener passes through the fourth connecting hole and the eighth connecting hole for connecting the second frame member and the fourth frame member.

The assembled-type filter structure as described above, the first frame assembly comprises a first frame member and a third frame member pivotally connected to the first frame member, the second frame assembly comprises a second frame member and a fourth frame member pivotally connected to the second frame member, the first frame member and the third frame member are configured to be relatively folded and overlapped, the second frame member and the fourth frame member are configured to be relatively folded and overlapped.

The assembled-type filter structure as described above, a first positioning member is arranged on the first frame member and adapted to an upper mounting rail inside a ventilation pipe, and the first positioning member is embedded in an inner side of the upper mounting rail for retaining the first frame member on the upper mounting rail.

The assembled-type filter structure as described above, a second positioning member is arranged on the second frame member and adapted to a lower mounting rail inside the ventilation pipe, and the second positioning member is embedded in the inner side of the lower mounting rail for retaining the second frame member on the lower mounting rail.

The assembled-type filter structure as described above, each of the first positioning member and the second positioning member comprises a connecting portion connected to the first frame assembly, and a positioning portion arched away from the first frame assembly.

The assembled-type filter structure as described above, a length of the positioning portion is L, a width of each of the upper mounting rail and the lower mounting rail is S, and a height of each of the upper mounting rail and the lower mounting rail is H, where S-L < H.

Compared with the prior art, the present invention has the following beneficial effects.

An assembled-type filter structure of the present invention, by designing the frame into a first frame assembly and a second frame assembly that are detachably connected, enables the filter to be disassembled and folded during transportation and storage, significantly reducing packaging volume of finished product and lowering logistics costs and warehousing pressure. Meanwhile, during installation, a connecting and matching process of the first frame assembly and the second frame assembly provides structural support and positioning for the expansion of the filter body, enabling it to be easily expanded and to fill the formed mounting opening.

### BRIEF DESCRIPTION OF THE DRAWINGS

In order to illustrate the technical solutions in the embodiments of the present invention more clearly, the accompany drawings required in the descriptions of the embodiments will be briefly introduced hereafter. Obviously, the accompany drawings in the following description are merely some embodiments of the present invention. For those of ordinary skill in the art, other accompany drawings can be obtained based on these drawings without exerting creative efforts.

FIG. 1 is a perspective view according to the present invention.

FIG. 2 is a partial exploded view of FIG. 1.

FIG. 3 is an exploded schematic view of embodiment 1 according to the present invention.

FIG. 4 is an exploded schematic view of embodiment 2 according to the present invention.

FIG. 5 is a side view of FIG. 1.

FIG. 6 is a schematic view of the folding process of the first frame assembly in the embodiment 2 according to the present invention.

FIG. 7 is a schematic view of the completed folded state of the first frame assembly in the embodiment 2 according to the present invention.

FIG. 8 is a schematic view of the installation rails in ventilation pipe.

FIG. 9 is a side view of FIG. 8.

### DETAILED DESCRIPTION OF THE DRAWINGS AND THE PRESENTLY PREFERRED EMBODIMENTS

In order to make the technical problems, technical solutions and beneficial effects solved by the present invention more clearly, the present invention is further illustrated hereafter in combination with the accompany drawings and embodiments. It should be understood that the embodiments described here are only used for explaining the present invention but not to limit the present invention.

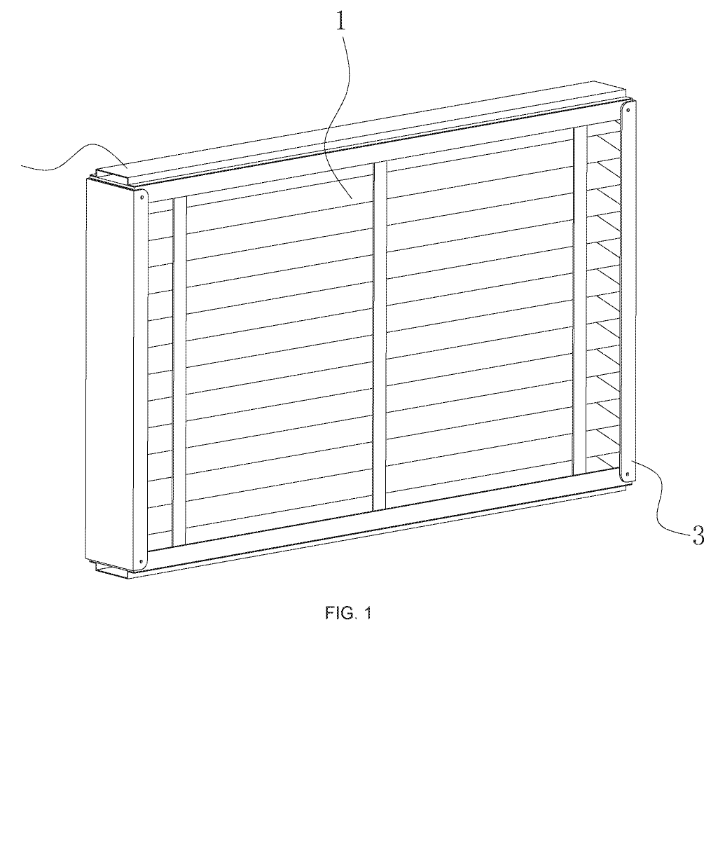

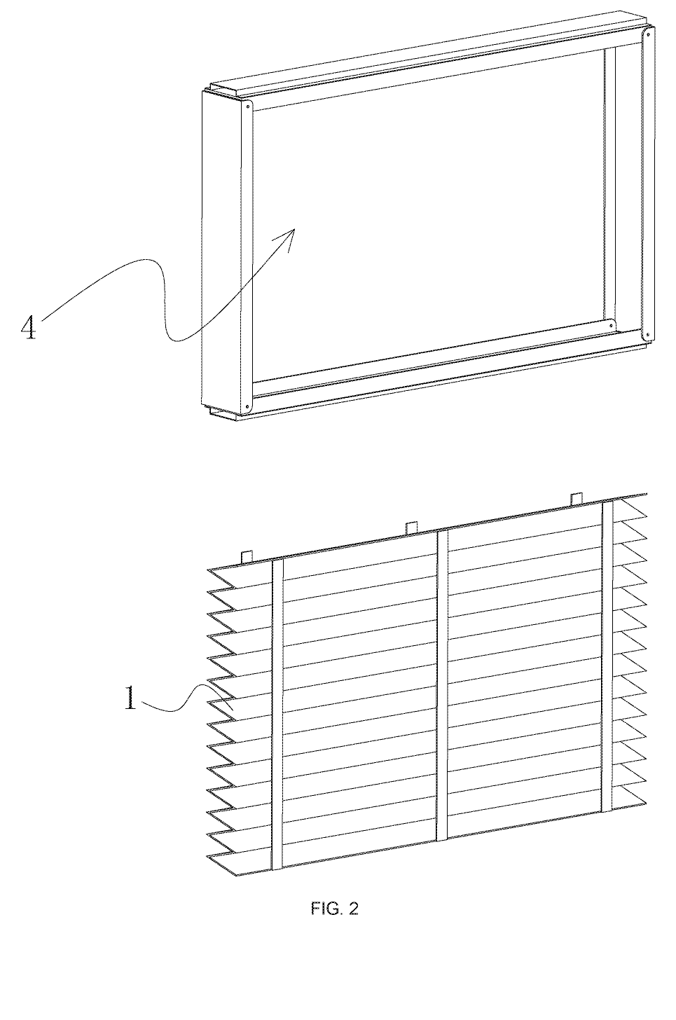

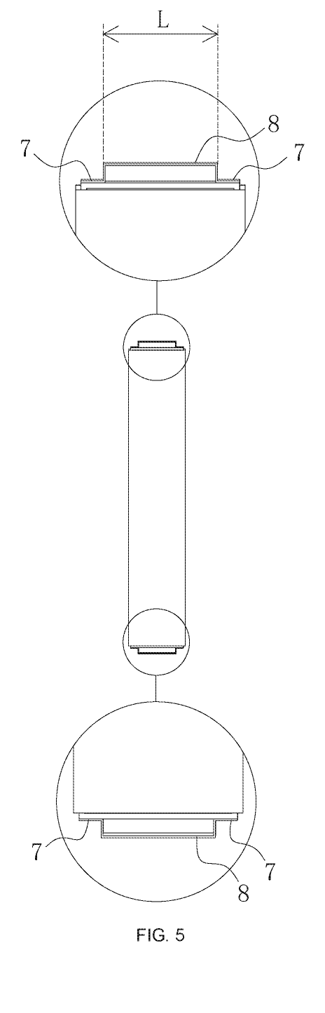

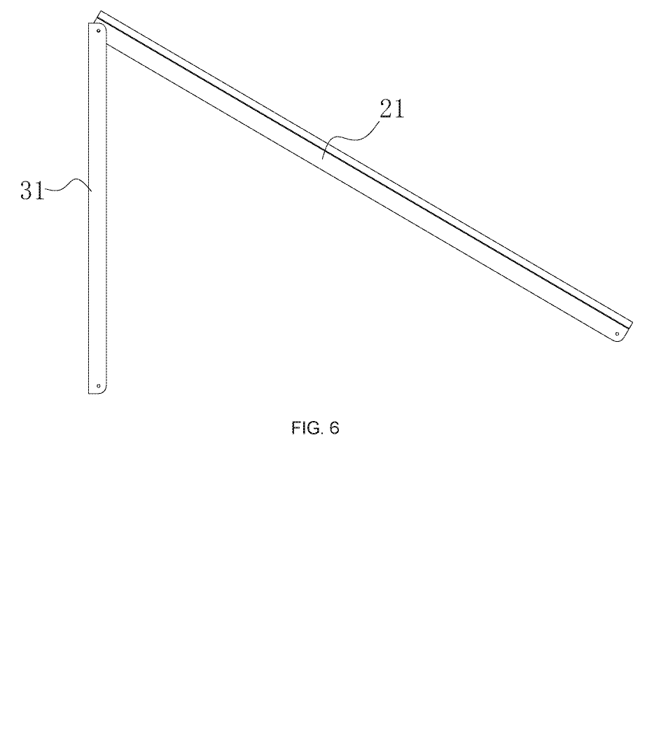

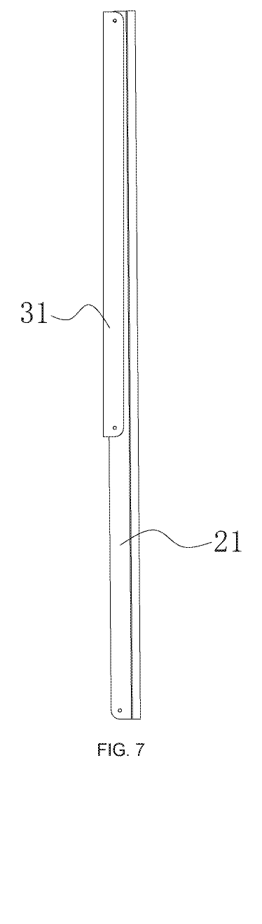

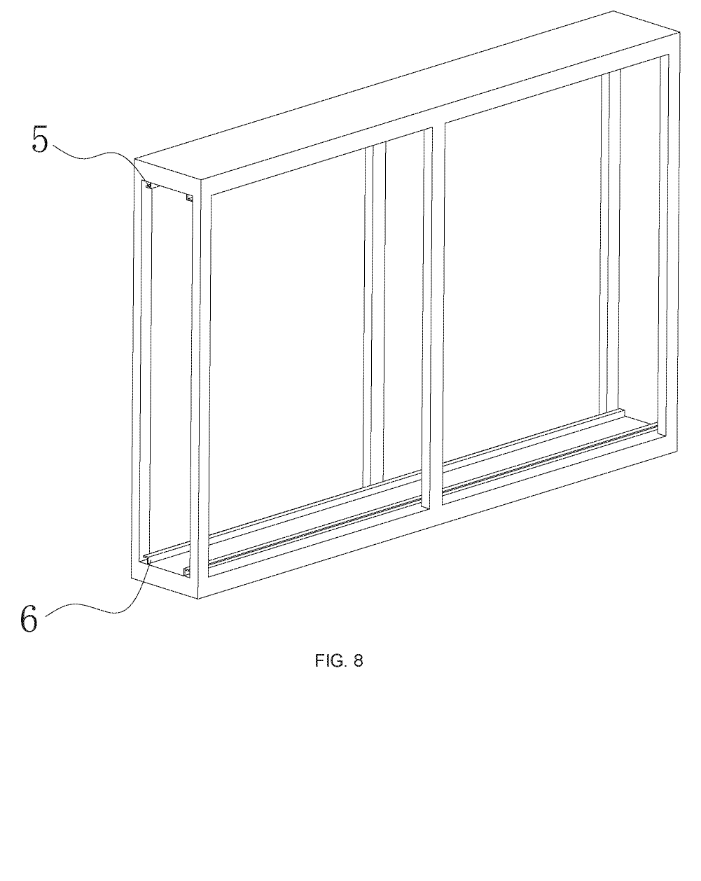

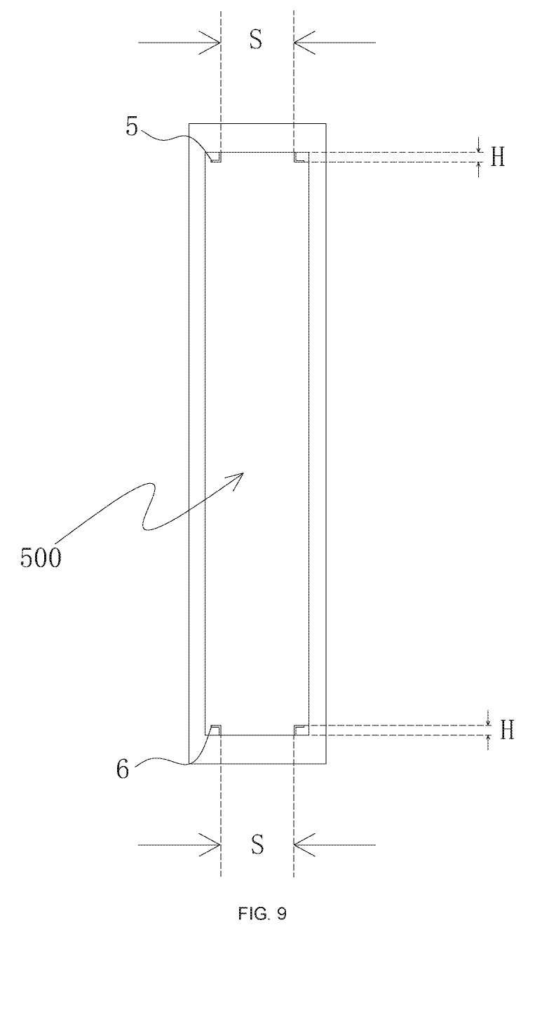

Please refer to FIGS. 1-9, an assembled-type filter structure is provided, comprising a filter body 1, a first frame assembly 2, and a second frame assembly 3 detachably connected to the first frame assembly 2, wherein the first frame assembly 2 and the second frame assembly 3 are connected and matched for the filter body 1 to be expanded and joined with the first frame assembly 2 and the second frame assembly 3, and to fill a mounting opening 4 formed by connecting the first frame assembly 2 with the second frame assembly 3.

The assembled-type filter structure of the present invention, by designing a frame into a first frame assembly and a second frame assembly that are detachably connected, enables the filter to be disassembled and folded during transportation and storage, significantly reducing packaging volume of finished product and lowering logistics costs and warehousing pressure. Meanwhile, during installation, a connecting and matching process of the first frame assembly and the second frame assembly provides structural support and positioning for the expansion of the filter body, enabling it to be easily expanded and to fill the formed mounting opening.

Further, as a preferred implementation method of this solution rather than a limitation, the first frame assembly 2 comprises a first frame member 21 and a second frame member 22 that are connected to two ends of the filter body 1 along a stretching direction of the filter body 1, the second frame assembly 3 comprises a third frame member 31 and a fourth frame member 32 that are detachably connected to the first frame member 21 and the second frame member 22, and are configured for supporting and expanding the filter body 1.

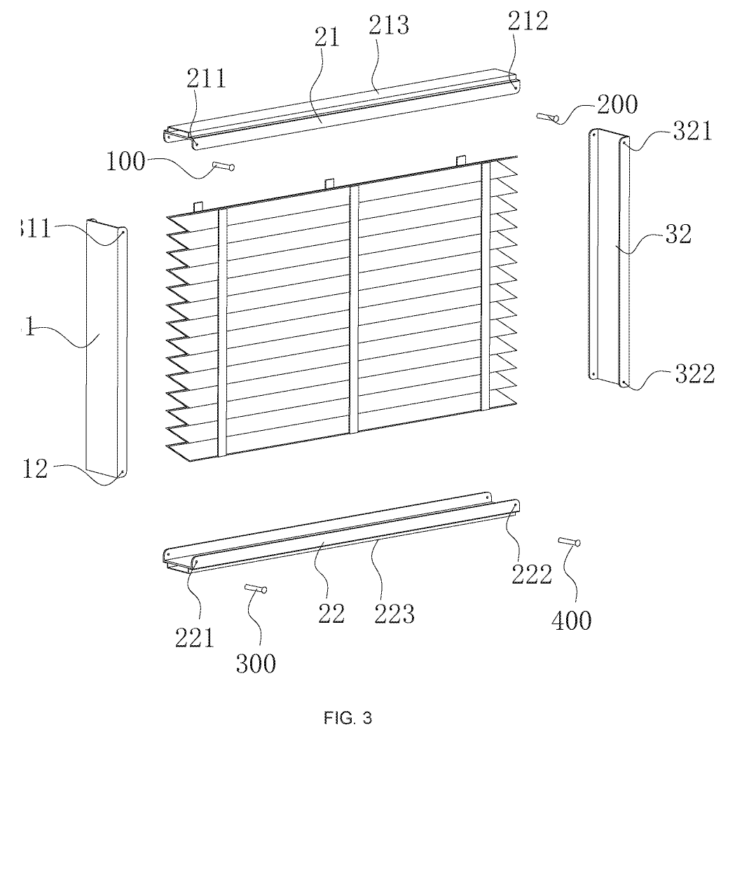

In embodiment 1, as shown in FIG. 3, by designing the frame into split and assemblable members: a first frame member, a second frame member, a third frame member, and a fourth frame member. During assembly, the first frame member and the second frame member that are fixed to two ends of the filter body along the stretching direction via adhesive bonding or a connecting structure, are combined with the detachable third frame member and fourth frame member, enabling the finished filter to be folded during storage and transportation, reducing packaging volume and lowering logistics costs. During installation, after two ends of the filter connected to the frames, the filter body is configured to be actively stretched from a compressed state to an expanded state and fixed therein, ensuring the flatness of the filter to improve filtration performance.

Further, as a preferred implementation method of this solution rather than a limitation, the filter body 1 is detachably connected to the first frame member 21 and the second frame member 22.

Further, as a preferred implementation method of this solution rather than a limitation, two ends of the first frame member 21 are provided with a first connecting hole 211 and a second connecting hole 212 respectively, two ends of the second frame member 22 are provided with a third connecting hole 221 and a fourth connecting hole 222 respectively, two ends of the third frame member 31 are provided with a fifth connecting hole 311 and a sixth connecting hole 312 respectively, two ends of the fourth frame member 32 are provided with a seventh connecting hole 321 and an eighth connecting hole 322 respectively, a first fastener 100 passes through the first connecting hole 211 and the fifth connecting hole 311 for connecting the first frame member 21 and the third frame member 31; a second fastener 200 passes through the second connecting hole 212 and the seventh connecting hole 321 for connecting the first frame member 21 and the fourth frame member 32; a third fastener 300 passes through the third connecting hole 221 and the sixth connecting hole 312 for connecting the second frame member 22 and the third frame member 31; a fourth fastener 400 passes through the fourth connecting hole 222 and the eighth connecting hole 322 for connecting the second frame member 22 and the fourth frame member 32.

In this embodiment, by configuring connecting holes at the ends of each of the four frame members, and using fasteners to pass through corresponding holes for achieving a four-corner connection, an assembly method is provided with low manufacturing cost, extremely simple structure, high connection strength and significant stability. Its working principle is as follows: during installation, the frame members configured for supporting and expanding are aligned with the end holes of the frame members for fixing the filter, and the fasteners are inserted and tightened. This process forcibly stretches and fixes the filter body to form a rigid frame, ensuring the flatness and wind pressure resistance of the filter.

Further, as a preferred implementation method of this solution rather than a limitation, the first frame assembly 2 comprises a first frame member 21 and a third frame member 31 pivotally connected to the first frame member 21, the second frame assembly 3 comprises a second frame member 22 and a fourth frame member 32 pivotally connected to the second frame member 22, the first frame member 21 and the third frame member 31 are configured to be relatively folded and overlapped, the second frame member 22 and the fourth frame member 32 are configured to be relatively folded and overlapped.

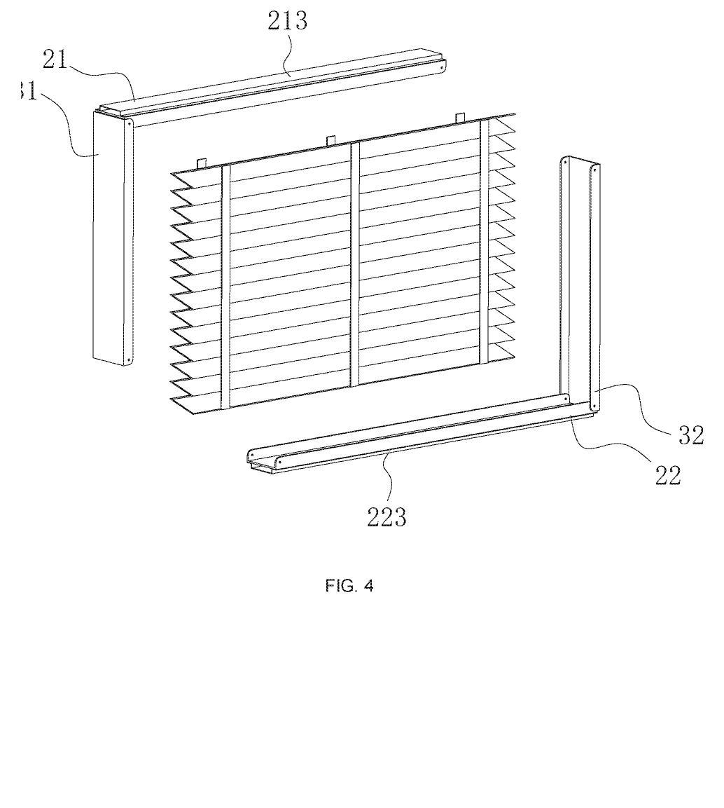

In embodiment 2, as shown in FIG. 4, by designing the frame members as two sets of pivotally connected assemblies, namely, the first frame member pivotally connected to the third frame member and the second frame member pivotally connected to the fourth frame member, or the first frame member pivotally connected to the fourth frame member and the second frame member pivotally connected to the third frame member, the installation steps are further simplified. Its working principle is as follows: during storage and transportation, the two sets of assemblies are each folded and overlapped to reduce volume; during installation, workers only need to pivot and expand them respectively to form two L-shaped structures, and then butt-joint and lock free ends of the two L-shaped assemblies. This connection action thereby automatically stretches and expands the filter body fixed on the first and the second frame members to form a stable rectangular frame.

Further, as a preferred implementation method of this solution rather than a limitation, a first positioning member 213 is arranged on the first frame member 21 and adapted to an upper mounting rail 5 inside a ventilation pipe 500, and the first positioning member 213 is embedded in an inner side of the upper mounting rail 5 for retaining the first frame member 21 on the upper mounting rail 5.

In this embodiment, by providing the first positioning member capable of being embedded in the inner side of the upper mounting rail, the force-bearing mode and operation logic of installation are changed since the third frame member and the fourth frame member support the filter body, there is no need to adopt a traditional installation method of hanging and stretching the filter body, which improves the installation convenience and stability. Its working principle is as follows: an installer first easily embeds the first frame member into the upper mounting rail by means of the positioning member, guidance provided by the inner side of the rail enables it to be accurately and stably retained in position, and the third and fourth frame members have already realized the support of the filter body. This reduces the installation difficulty and saves time.

Further, as a preferred implementation method of this solution rather than a limitation, a second positioning member 223 is arranged on the second frame member 22 and adapted to a lower mounting rail 6 inside the ventilation pipe 500, and the second positioning member 223 is embedded in the inner side of the lower mounting rail 6 for retaining the second frame member 22 on the lower mounting rail 6.

In this embodiment, by providing the second positioning member capable of being embedded in the inner side of the lower mounting rail, the force-bearing mode and operation logic of installation are changed since the third frame member and the fourth frame member support the filter body, there is no need to adopt the traditional installation method of hanging and stretching the filter body, which improves the installation convenience and stability. Its working principle is as follows: an installer first easily embeds the second frame member into the lower mounting rail by means of the positioning member, guidance provided by the inner side of the rail enables it to be accurately and stably retained in position, and the third and fourth frame members have already realized the support of the filter body. This reduces the installation difficulty and saves time.

Further, as a preferred implementation method of this solution rather than a limitation, each of the first positioning member 213 and the second positioning member 223 comprises a connecting portion 7 connected to the first frame assembly 2, and a positioning portion 8 arched away from the first frame assembly 2.

In this embodiment, when the frame member is pushed into the mounting rail, the positioning portion cooperates with the inner side of the mounting rail. This design is configured for retaining the frame member in the rail, preventing it from shaking or falling off, and effectively adapting to the dimensional tolerances inside the rail.

Further, as a preferred but non-limiting implementation of the present solution, a length of the positioning portion 8 is L, a width of each of the upper mounting rail 5 and the lower mounting rail 6 is S, and a height of each of the upper mounting rail 5 and the lower mounting rail 6 is H, where S-L < H.

In this embodiment, by defining a specific relationship among the length of the positioning portion, the opening width of the rail, and the rail height, a simple yet extremely stable anti-falling lock is realized. Its working principle is as follows: during installation, the positioning portion with a shorter length is inserted into a rail opening with a larger width, allowing the positioning portion to be easily embedded into the inner side of the mounting rail, and a design of lateral distance difference (S-L) is smaller than the vertical height H of the rail. Once the positioning portion is translated into place, it is restricted by the rail height in the vertical direction; to disassemble it, it is necessary to overcome both the rail height and the lateral gap, thereby effectively preventing the frame from accidentally falling off due to vibration or air flow impact. It only needs to be pulled out along the length direction of the mounting rail.

The working principle of the embodiment are as follows:

An assembled-type filter structure of the present invention, by designing the frame into a first frame assembly and a second frame assembly that are detachably connected, enables the filter to be disassembled and folded during transportation and storage, significantly reducing packaging volume of finished product and lowering logistics costs and warehousing pressure. Meanwhile, during installation, a connecting and matching process of the first frame assembly and the second frame assembly provides structural support and positioning for the expansion of the filter body, enabling it to be easily expanded and to fill the formed mounting opening.

The above described are implementation methods provided in combination with the specific contents, and it is not determined that the specific embodiments of the present invention are limited to these descriptions. Any methods and structures that are similar to the present invention, or any technical deductions or substitutions made under the premises of the present invention, should be regarded as the protection scope of the present invention.

1. An assembled-type filter structure, comprising a filter body, a first frame assembly, and a second frame assembly detachably connected to the first frame assembly, wherein the first frame assembly and the second frame assembly are connected and matched for the filter body to be expanded and joined with the first frame assembly and the second frame assembly, and to fill a mounting opening formed by connecting the first frame assembly with the second frame assembly.

2. The assembled-type filter structure of claim 1, wherein the first frame assembly comprises a first frame member and a second frame member that are connected to two ends of the filter body along a stretching direction, the second frame assembly comprises a third frame member and a fourth frame member that are detachably connected to the first frame member and the second frame member, and are configured for supporting and expanding the filter body.

3. The assembled-type filter structure of claim 2, wherein the filter body is detachably connected to the first frame member and the second frame member.

4. The assembled-type filter structure of claim 2, wherein two ends of the first frame member are provided with a first connecting hole and a second connecting hole respectively, two ends of the second frame member are provided with a third connecting hole and a fourth connecting hole respectively, two ends of the third frame member are provided with a fifth connecting hole and a sixth connecting hole respectively, two ends of the fourth frame member are provided with a seventh connecting hole and an eighth connecting hole respectively,
a first fastener passes through the first connecting hole and the fifth connecting hole for connecting the first frame member and the third frame member; a second fastener passes through the second connecting hole and the seventh connecting hole for connecting the first frame member and the fourth frame member; a third fastener passes through the third connecting hole and the sixth connecting hole for connecting the second frame member and the third frame member; a fourth fastener passes through the fourth connecting hole and the eighth connecting hole for connecting the second frame member and the fourth frame member.

5. The assembled-type filter structure of claim 1, wherein the first frame assembly comprises a first frame member and a third frame member pivotally connected to the first frame member, the second frame assembly comprises a second frame member and a fourth frame member pivotally connected to the second frame member, the first frame member and the third frame member are configured to be relatively folded and overlapped, the second frame member and the fourth frame member are configured to be relatively folded and overlapped.

6. The assembled-type filter structure of claim 2, wherein a first positioning member is arranged on the first frame member and adapted to an upper mounting rail inside a ventilation pipe, and the first positioning member is embedded in an inner side of the upper mounting rail for retaining the first frame member on the upper mounting rail.

7. The assembled-type filter structure of claim 6, wherein a second positioning member is arranged on the second frame member and adapted to a lower mounting rail inside the ventilation pipe, and the second positioning member is embedded in the inner side of the lower mounting rail for retaining the second frame member on the lower mounting rail.

8. The assembled-type filter structure of claim 7, wherein each of the first positioning member and the second positioning member comprises a connecting portion connected to the first frame assembly, and a positioning portion arched away from the first frame assembly.

9. The assembled-type filter structure of claim 8, wherein a length of the positioning portion is L, a width of each of the upper mounting rail and the lower mounting rail is S, and a height of each of the upper mounting rail and the lower mounting rail is H, where S-L < H.
